(19) United States
(12) Patent Application Publication
(10) Pub. No.: US 2004/0179352 A1
(43) Pub. Date: Sep. 16, 2004

(54) Luminescent aircraft marshaling wand

(76) Inventors: Wade R. Anderson, Humble, TX (US); Simplicia C. S. Anderson, Humble, TX (US)

Correspondence Address: Michael L. Diaz, Michael L. Diaz, P.C., Suite 200, 555 Republic Drive, Plano, TX, 75074, US

(21) Appl. No.: 10/386,842

(22) Filed: Mar. 12, 2003

(51) Int. Cl. F21V 33/00

(52) U.S. Cl. 362/109; 362/84

(57) ABSTRACT

An aircraft marshaling wand having luminescent properties. The marshaling wand includes a wand segment having a surface mixed with a luminescent material. The wand segment is affixed to a handle for carriage by a guideman. The wand segment is illuminated after exposure to a light source. Alternatively, the luminescent material may be affixed to safety vests, safety equipment, and underwater diving equipment.

### BACKGROUND OF THE INVENTION

1. Technical Field of the Invention

This invention relates to luminescent devices, and more particularly, to an aircraft marshaling wand having luminescent properties.

2. Description of Related Art

When taxing to a known position on a tarmac or a gate at an airport, oftentimes pilots require personnel located on the ground to guide the pilots to a desired position. The ground personnel utilize standardized gestures with their hands to guide the pilots in taxing the aircraft to the desired position. Preferably, the ground personnel utilize lighted wands. It is quite common, especially at night or in bad weather, that the pilot cannot see the ground personnel, but can only see the wands. The wands typically include a conventional flashlight base with a light that illuminates a portion of the wand. These existing wands suffer from several disadvantages. The batteries frequently die at the most inopportune time, specifically during the marshaling of an aircraft at night, when it is too late to change the batteries. The batteries may also be weak causing the wands to illuminate a very weak light which is difficult to see. This dim light may not be sufficient for the pilot to see the wands. In addition, the bulbs may burn out. It is imperative, from a safety standpoint, that the wands always provide sufficient illumination to the wand. A marshaling wand is needed which consistently provides a sufficient light in the wand and which does not require replacement of batteries or bulbs.

Although there are no known prior art teachings of a device such as that disclosed herein, prior art references that discuss subject matter that bears some relation to matters discussed herein are U.S. Pat. No. 5,595,434 to Scolari et al. (Scolari), U.S. Pat. No. 5,595,434 to Pasch et al. (Pasch), and U.S. Pat. No. 5,642,931 to Gappelberg (Gappelberg).

Scolari discloses a toy light sword having a hollow blade with a fluorescent coating on the inside of the sword. A stroboscopic lamp unit is discharged by a switch to provide a burst of light and a glow on the sword blade. However, Scolari does not teach or suggest coating an exterior portion of a rod or wand with a phosphorescence material. Scolari merely discloses a toy which includes illumination from the blade. Additionally, since the coating is located on the inside of the sword, the illumination is obscured by the outer surface of the blade.

Pasch discloses a flashlight wand attachment having a wand member with a truncated conical portion and an opposing member. The attachment also includes threads for fastening the wand member to the opposing member when the wand member is disposed at one end of a wide portion or lamp housing of a handle member or flashlight. Pasch does not teach or suggest a phosphorescence material coated upon an exterior surface of a wand. Pasch merely discloses a device providing an illumination of a wand attachment.

Gappelberg discloses a hand-held beacon for hailing taxicabs. The device includes a handle which includes a button for releasing a protruding member from a groove in a light element. The light member is tubular in shape and includes a circuit to cause a bulb at the top of the handle portion to beam light through the light element. The light element has a reflective blocking layer adhesively attached to the inside of the tube which defines the letters of the word “TAXI.” However, Gappelberg does not teach or suggest a phosphorescence material for illuminating a wand.

Review of the foregoing references reveals no disclosure or suggestion of an aircraft marshaling wand having luminescent properties. It is an object of the present invention to provide such an apparatus.

### SUMMARY OF THE INVENTION

In one aspect, the present invention is an aircraft marshaling wand having luminescent properties. The wand includes a handle and a wand segment attached to the handle. The wand segment has a surface with a luminescent material. The wand segment is illuminated after exposure to a light source. The luminescent material may be mixed with another material to form the surface of the wand segment or the luminescent material may be coated to the surface. In addition, the luminescent material may be located on both the wand segment and the handle.

In another aspect, the present invention is a method of utilizing luminescent material with an aircraft marshaling wand. The method begins by applying a luminescent material to a portion of an aircraft marshaling wand. Next, the luminescent material is exposed to a light source. The luminescent material then emits a light to illuminate the portion of the outer surface of the aircraft marshaling wand.

In still another aspect, the present invention is a piece of clothing having luminescent properties. The piece of clothing has a surface. A luminescent material is applied to a portion of the surface. The luminescent material may be mixed with another material to form the surface or the luminescent material may be coated to the surface. The luminescent material is illuminated after exposure to a light source. The piece of clothing may be a safety vest or diving equipment worn by an underwater diver.

In another aspect, the present invention is a safety device having luminescent properties. The safety device has a surface. A luminescent material is applied to a portion of the surface. The luminescent material may be mixed with another material to form the surface or the luminescent material may be coated to the surface. The luminescent material is illuminated after exposure to a light source.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a front view of a luminescent marshaling wand in the preferred embodiment of the present invention;

FIG. 2 is a front view of a guideman holding the marshaling wands signaling the aircraft to move straight ahead;

FIG. 3 is a front view of the guideman holding the marshaling wands signaling the aircraft to turn right;

FIG. 4 is a front view of the guideman holding the marshaling wands signaling the aircraft to turn left;

FIG. 5 illustrates a front view of a vest in an alternate embodiment of the present invention; and

FIG. 6 illustrates a diver having a mask, an oxygen tank, fins, and a wet suit in a second alternate embodiment of the present invention.

### DETAILED DESCRIPTION OF EMBODIMENTS

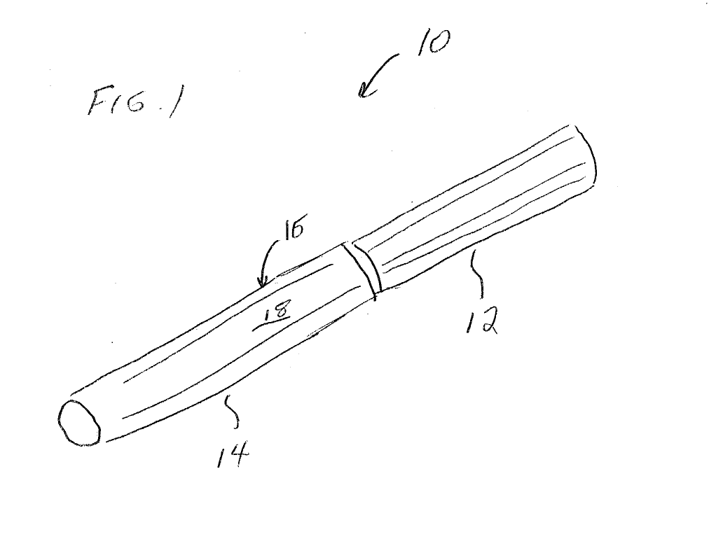

An aircraft marshaling wands having luminescent properties is disclosed. FIG. 1 is a front view of a luminescent marshaling wand 10 in the preferred embodiment of the present invention. The marshaling wand includes a handle 12 attached to a wand section 14. The wand section may take any shape and size. However, in the preferred embodiment of the present invention, the wand section is elongated to provide enhanced visibility to the pilot. The wand section includes a surface 16. In the preferred embodiment of the present invention, a luminescent material 18 is mixed with the surface. However, in an alternate embodiment of the present invention, the luminescent material is coated upon the surface.

The luminescent material is preferably a material having superior photoluminescence qualities, such as manufactured by ProGlow Manufacturing Company, Inc. (ProGlow). ProGlow manufactures a pigment powder which glows for up to 20 hours after a ten minute exposure to a visible light source. Substances that can convert absorbed energy into visible light is called fluorescence. The re-emitted light surviving after the excitation is called phosphorescence. The longer afterglow of phosphorescence is called photoluminescence. In the watch industry, zinc sulfide and copper is used as a phosphorescence. However, this material is not effective for aircraft marshaling wands because of its low luminosity and quick fading. The ProGlow powder may have a luminosity as high as 2780 mcd/m2 immediately after the removable of the light source. The luminescent material may be mixed with another material (e.g., plastic) to form the surface of wand section during manufacture of the wand section. Typically, the wand section is constructed of a plastic material. The plastic material is poured into a mold. Prior to hardening, the luminescent material may be added to the plastic material to provide a luminescent property to the surface of the wand section. In the alternate embodiment of the present invention, the luminescent material is coated upon an outer side of the surface.

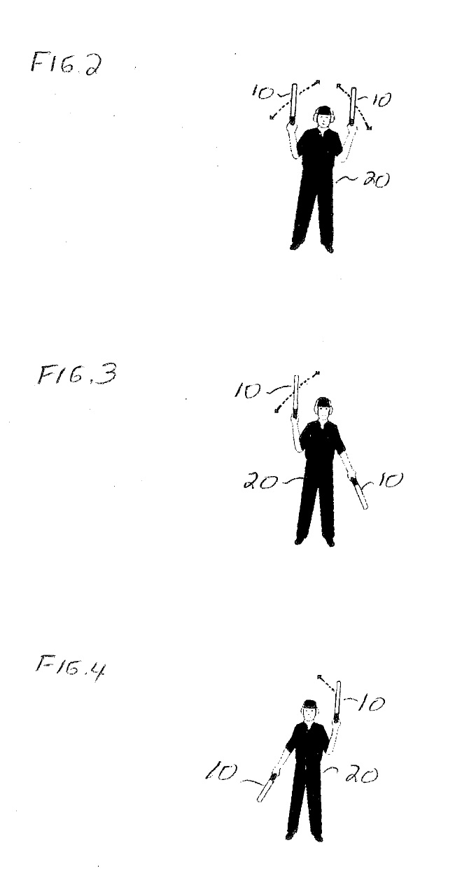

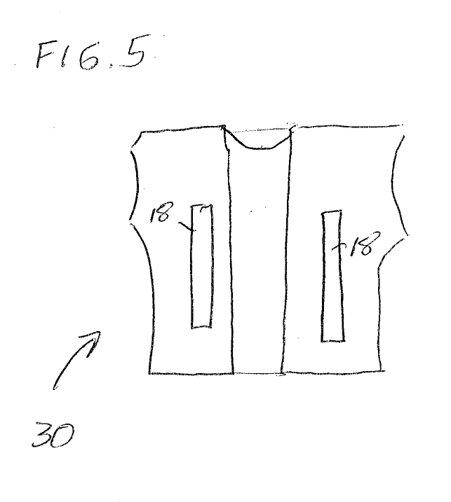

FIG. 2 is a front view of a guideman 20 holding the marshaling wands 10 signaling the aircraft to move straight ahead. FIG. 3 is a front view of the guideman 20 holding the marshaling wands 10 signaling the aircraft to turn right. FIG. 4 is a front view of the guideman 20 holding the marshaling wands 10 signaling the aircraft to turn left. The marshaling wands 10 enable the guideman to signal the pilot at night or in inclement weather.

With reference to FIGS. 1-4, the operation of the marshaling wands 10 will now be explained. The marshaling wands are positioned under a light source, such as a lamp. The luminescent material 18 absorbs the light. After approximately a ten minute exposure to the light source, the marshaling wands may be used. The marshaling wands are held at the handles 12. As illustrated in FIG. 2, the guideman may guide the aircraft straight ahead. The guideman may also guide the aircraft to the right (FIG. 3) or the left (FIG. 4). There are various other standardized signals that are used by guideman to communicate with the pilot.

The marshaling wand may be in any shape or configuration which enables a pilot to observe the hand signals of the guideman. For example, the wand may be cylindrically or conically shaped and include the luminescent material on all surface areas. Additionally, the luminescent material may be affixed to existing wands. The luminescent material may alternatively be affixed to a portion of the outer surface of the wand, rather than mixed with the surface material comprising the entire wand section. In addition, the luminescent material may be located on a portion or all of the marshaling wand. For example, the luminescent material may be located in both the wand section and the handle.

The present invention provides several advantages over existing aircraft marshaling wands. The present invention provides consistently bright light emanating from the wands for a long period of time, without the need for batteries or bulbs. Thus, costs are reduced since replacement parts are no longer needed. In addition, since the light is not powered by batteries and illuminated by light bulbs, the luminosity of the wands is assured at all times.

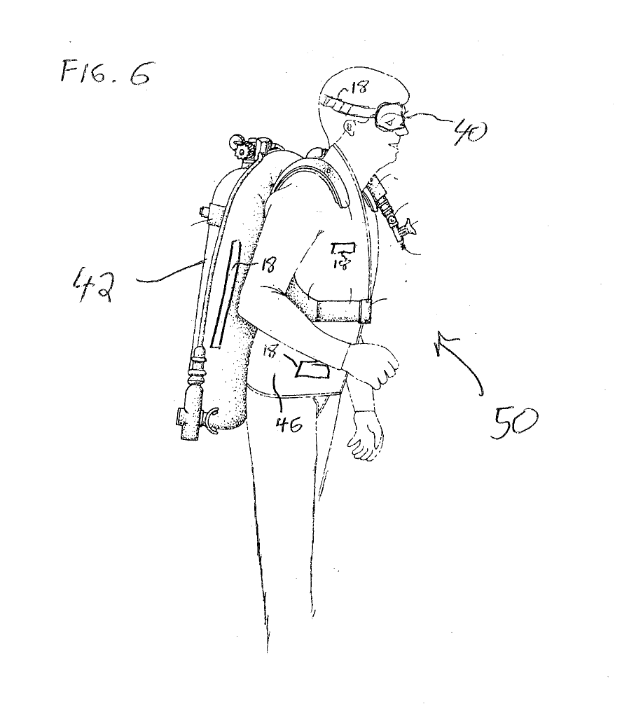

In an alternate embodiment of the present invention, the luminescent material may be affixed to safety vests as is worn by ground personnel at an airport or police at road hazards. FIG. 5 illustrates a front view of a vest 30 in an alternate embodiment of the present invention. The luminescent material 18 is either mixed with the material of the vest or affixed directly to a vest. Alternately, the luminescent material may be mixed with a rubber or plastic product. The rubber or plastic product may then be affixed to the vest. In existing safety vests, a reflective tape is affixed to the vest to highlight the person wearing the vest. However, existing vests must have a light source reflected against the reflective material. The vest 30 utilizes the luminescent material to illuminate the vest wearer without the need of a light source to reflect light off the vest.

Additionally, in a similar fashion as discussed for the vest 30, the luminescent material may be utilized with other types of clothing, such as a raincoat. A raincoat includes a rubberized material which may be mixed with the luminescent material.

The luminescent material may also be utilized with other safety equipment, such as hazard cones. These cones are often utilized to warn drivers of road hazards. The luminescent material may be mixed with the another material, such as plastic, to form the cone. The cone thus provides illumination to drivers.

In another example, the luminescent material may be utilized with life vests found on aircraft and within boats. The life vests may include the luminescent material applied to a portion of the life vests (e.g., mixed with another material to form a portion of the life vest, coated upon a portion of the outer surface of the life vest, or mixed with a product which is affixed to the life vest). With existing life vests, no illumination emanates from the life vest. Rather, reflective tape is utilized. The present invention enables the life vest to illuminate without the addition of other illumination devices, such as flares or flashlights.

In still another example used in safety equipment, the luminescent material may be applied to a portion of a life raft. In a similar fashion as existing life vests, existing life rafts do not include illumination properties incorporated with the life rafts. The present invention may utilize the luminescent material by applying the luminescent material to a portion of the life raft (e.g., mixed with another material to form a portion of the life raft, coated upon a portion of the outer surface of the life raft, or mixed with a product which is affixed to the life raft).

In still another alternate embodiment of the present invention, the luminescent material may be affixed directly to a wide variety of underwater diving equipment. FIG. 6 illustrates a diver 50 having a mask 40, an oxygen tank 42, and a wet suit 46 in a second alternate embodiment of the present invention. In existing diving gear, reflective tape is affixed to the wet suit of the diver. However, as discussed above, the reflective tape is only effective when a light is shown against the tape. The present invention may mix the luminescent material with a portion of material comprising the diving gear (e.g., mask, tank, fins, wet suit, buoyance control device, or any other diving gear). Specifically, the luminescent material may be mixed with the rubber/plastic portions of the diving equipment. With rubber or plastic material, the luminescent material may be easily mixed during the manufacture of the product. The luminescent material may be waterproof. After an exposure to a light source, the luminescent material emits a light. In an alternate embodiment of the present invention, the luminescent material may be affixed to an outer surface of the diving gear. Alternately, the luminescent material is mixed with plastic or rubber products which are affixed to a portion of the diving equipment.

It is thus believed that the operation and construction of the present invention will be apparent from the foregoing description. While the apparatus and method shown and described has been characterized as being preferred, it will be readily apparent that various changes and modifications could be made therein without departing from the scope of the invention as defined in the following claims.

What is claimed is:

1. An aircraft marshaling wand having luminescent properties, said wand comprising:
a handle; and
a wand segment attached to the handle, said wand segment having a surface with a luminescent material;
whereby said wand segment is illuminated after exposure to a light source.

2. The aircraft marshaling wand of claim 1 wherein the luminescent material is mixed with a material to form the surface of the wand section.

3. The aircraft marshaling wand of claim 1 wherein the surface is coated with the luminescent material.

4. The aircraft marshaling wand of claim 1 wherein the luminescent material has a luminosity of approximately 2780 mcd/m2 immediately after removal from the light source

5. The aircraft marshaling wand of claim 1 wherein said wand segment is elongated.

6. The aircraft marshaling wand of claim 5 wherein said elongated wand segment is cylindrically shaped.

7. The aircraft marshaling wand of claim 5 wherein said elongated wand segment is conically shaped.

8. The aircraft marshaling wand of claim 1 wherein luminescent material is mixed with a material to form the surface of said wand section and said handle.

9. A method of utilizing luminescent material with an aircraft marshaling wand, said method comprising the steps of:
applying a luminescent material to a portion of an aircraft marshaling wand;
exposing the luminescent material to a light source; and
emitting a light by the luminescent material to illuminate the portion of the outer surface of the aircraft marshaling wand.

10. The method of utilizing luminescent material with an aircraft marshaling wand of claim 9 wherein the step of applying a luminescent material to a portion of an aircraft marshaling wand includes mixing the luminescent material with a material to form a surface of the aircraft marshaling wand.

11. The method of utilizing luminescent material to coat an aircraft marshaling wand of claim 9 wherein the marshaling wand includes an elongated wand segment, the luminescent material being applied to said wand segment.

12. A piece of clothing having luminescent properties, said piece of clothing comprising:
a piece of clothing having a surface; and
a luminescent material applied to a portion of the surface;
whereby said luminescent material is illuminated after exposure to a light source.

13. The piece of clothing of claim 12 wherein the luminescent material is mixed with a material to form the surface.

14. The piece of clothing of claim 12 wherein the surface is coated with the luminescent material.

15. The piece of clothing of claim 12 wherein said piece of clothing is a safety vest.

16. The piece of clothing of claim 12 wherein said piece of clothing is diving equipment worn by a diver.

17. A safety device having luminescent properties, said safety device comprising:
a safety device having a surface; and
a luminescent material applied to a portion of the surface;
whereby said luminescent material is illuminated after exposure to a light source.

18. The safety device of claim 17 wherein the luminescent material is mixed with a material to form the surface.

19. The safety device of claim 17 wherein the surface is coated with the luminescent material.

20. The safety device of claim 17 wherein the safety device is a hazard cone.

21. The safety device of claim 17 wherein the safety device is a life raft.

22. The safety device of claim 17 wherein the safety device is a life vest.
